(19) United States
(12) Patent Application Publication
(10) Pub. No.: US 2025/0261816 A1
(43) Pub. Date: Aug. 21, 2025

(54) SYSTEM AND METHOD FOR FACILITATING CLEANING AREA

(71) Applicant: Simpple Pte Ltd, Singapore (SG)

(72) Inventors: QiKai SOO, Singapore (SG); Patrick Kok Tong KOH, Singapore (SG); Jiyan WU, Singapore (SG)

(21) Appl. No.: 18/856,577

(22) PCT Filed: Feb. 20, 2023
(86) PCT No.: PCT/SG23/50099

§ 371 Date: Oct. 11, 2024

(30) Foreign Application Priority Data
Apr. 13, 2022 (SG) 10202203801Q

(51) Int. Cl. A47L 11/40; A47L 9/28; G06V 10/20; G06V 10/25; G06V 10/26; G06V 20/50

(52) U.S. Cl. CPC A47L 11/4011; A47L 9/2805; A47L 9/2852; G06V 10/25; G06V 10/255; G06V 10/26; G06V 20/50; A47L 2201/04; A47L 2201/06

(57) ABSTRACT

According to various embodiments, there is a system comprising: an image capturing module configured to capture an image of an area, the image comprising a target to be disposed of; at least one cleaning device configured to perform a task to dispose of the target; and a processor configured to: receive the image from the image capturing module; determine an attribute of the target and a location of the target from the image; and control the at least one cleaning device to perform the task, based on the determined attribute of the target and the determined location of the target, wherein the processor is further configured to detect a rough shape of the target from the image, and process the image in a different manner based on whether the target is of regular shape or irregular shape to determine the attribute of the target and the location of the target.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

Various embodiments are related to a system and a method for facilitating cleaning an area.

### 2. Description of Related Art Including Information Disclosed Under 37 CFR 1.97 and 37 CFR 1.98

In recent years, with the development of technologies, various types of robots are increasingly used. One of the examples of the robots is a cleaning robot. The cleaning robot can automatically clean a floor of a building or a house without a need of manual participation.

Conventionally, the cleaning robot performs a cleaning task according to manually set working modes, while automatically moving in a certain area to be cleaned. For example, according to the conventional technology, the cleaning robot may be able to clean the target detected while automatically traveling in the area. However, according to the conventional technology, the cleaning robot is unable to identify various types of targets to be cleaned. For example, the cleaning robot is unable to distinguish between a trash and a spillage to clean the trash or the spillage accordingly. Therefore, the user may be required to set a suitable working mode according to the type of the targets to be cleaned.

Therefore, it is important and necessary to develop a solution to address the above problem.

### BRIEF SUMMARY OF THE INVENTION

According to various embodiments, there is a system for facilitating cleaning an area, the system comprising: an image capturing module configured to capture an image of the area, the image comprising a target to be disposed of; at least one cleaning device configured to perform a task to dispose of the target; and a processor communicatively couplable with the image capturing module and the at least one cleaning device, and configured to: receive the image from the image capturing module; determine an attribute of the target and a location of the target from the image; and control the at least one cleaning device to perform the task, based on the determined attribute of the target and the determined location of the target, wherein the processor is further configured to detect a rough shape of the target from the image, and process the image in a different manner based on whether the target is of regular shape or irregular shape to determine the attribute of the target and the location of the target.

In some embodiments, the processor comprises an anomaly detection module configured to identify a region of interest associated with the target from the image using an anomaly detection model.

In some embodiments, the anomaly detection module is further configured to detect the rough shape of the target from the image using the anomaly detection model.

In some embodiments, the processor comprises an object detection module; and wherein if the anomaly detection module detects that the target is of the regular shape, the anomaly detection module is configured to determine that the target is a trash and send information about the region of interest to the object detection module.

In some embodiments, the object detection module is configured to determine the attribute of the target and the location of the target based on the received information, using an object detection model.

In some embodiments, the processor comprises a segmentation module; and wherein if the anomaly detection module detects that the target is of the irregular shape, the anomaly detection module is configured to determine that the target is a spillage and send information about the region of interest to the segmentation module.

In some embodiments, the segmentation module is configured to determine the attribute of the target and the location of the target based on the received information, using a segmentation model.

In some embodiments, the processor comprises an image processing module configured to convert the image into a format readable by at least one of the anomaly detection module, the object detection module, and the segmentation module.

In some embodiments, the processor comprises a scheduling module configured to receive the determined attribute of the target and the determined location of the target from the object detection module and/or the segmentation module, and control the at least one cleaning device to move to the determined location of the target and to perform the task in a predetermined manner based on the determined attribute of the target.

In some embodiments, if the at least one cleaning device is unable to perform the task, the scheduling module is further configured to send a notification to an electronic device of a user.

In some embodiments, the attribute of the target includes at least one of a shape, a type and a colour of the target.

According to various embodiments, there is a method for facilitating cleaning an area, the method comprising: capturing an image of the area, the image comprising a target to be disposed of; detecting a rough shape of the target from the image; processing the image in a different manner based on whether the target is of regular shape or irregular shape to determine an attribute of the target and a location of the target; determining the attribute of the target and the location of the target; and controlling at least one cleaning device to perform a task to dispose of the target, based on the determined attribute of the target and the determined location of the target.

In some embodiments, the method further comprises: identifying a region of interest associated with the target from the image using an anomaly detection model.

In some embodiments, the detecting a rough shape of the target from the image comprises: detecting the rough shape of the target from the image using the anomaly detection model.

In some embodiments, the method further comprises: if it is detected that the target is of the regular shape, determining that the target is a trash; and inputting information about the region of interest into an object detection model.

In some embodiments, the determining the attribute of the target and the location of the target comprises: determining the attribute of the target and the location of the target based on the inputted information, using the object detection model.

In some embodiments, the method further comprises: if it is detected that the target is of the irregular shape, determining that the target is a spillage; and inputting information about the region of interest into a segmentation model.

In some embodiments, the determining the attribute of the target and the location of the target comprises: determining the attribute of the target and the location of the target based on the inputted information, using the segmentation model.

In some embodiments, the controlling at least one cleaning device to perform a task to dispose of the target comprises: controlling the at least one cleaning device to move to the determined location of the target and to perform the task in a predetermined manner based on the determined attribute of the target.

In some embodiments, the method further comprises: if the at least one cleaning device is unable to perform the task, sending a notification to an electronic device of a user.

According to various embodiments, a data processing apparatus configured to perform the method of any one of the above embodiments is provided.

According to various embodiments, a computer program element comprising program instructions, which, when executed by one or more processors, cause the one or more processors to perform the method of any one of the above embodiments is provided.

According to various embodiments, a computer-readable medium comprising program instructions, which, when executed by one or more processors, cause the one or more processors to perform the method of any one of the above embodiments is provided. The computer-readable medium may include a non-transitory computer-readable medium.

Additional features for advantageous embodiments are provided in the dependent claims.

### BRIEF DESCRIPTION OF THE SEVERAL VIEWS OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings.

FIG. 1 illustrates an infrastructure of a system for facilitating cleaning an area according to various embodiments.

FIG. 2 illustrates a block diagram of a processor included in a system for facilitating cleaning an area according to various embodiments.

FIG. 3 illustrates a flowchart of a method for facilitating cleaning an area according to various embodiments.

FIG. 4 illustrates exemplary images processed by an anomaly detection module according to various embodiments.

FIG. 5 illustrates an exemplary image processed by an object detection module according to various embodiments.

FIG. 6 illustrates an exemplary image processed by a segmentation module according to various embodiments.

FIG. 7 illustrates an exemplary view showing an operation of at least one cleaning device according to various embodiments.

FIG. 8 illustrates an exemplary view showing an operation of at least one cleaning device according to various embodiments.

FIG. 9 illustrates an exemplary view showing an operation of at least one cleaning device according to various embodiments.

FIG. 10 illustrates an exemplary view showing an operation of at least one cleaning device according to various embodiments.

### DETAILED DESCRIPTION OF THE INVENTION

Embodiments described below in the context of the methods are analogously valid for the system, and vice versa. Furthermore, it will be understood that the embodiments described below may be combined, for example, a part of one embodiment may be combined with a part of another embodiment.

It will be understood that any property described herein for a specific device may also hold for any device described herein. Furthermore, it will be understood that for any device described herein, not necessarily all the components described must be enclosed in the device, but only some (but not all) components may be enclosed.

It should be understood that the terms “on”, “over”, “top”, “bottom”, “down”, “side”, “back”, “left”, “right”, “front”, “lateral”, “side”, “up”, “down” etc., when used in the following description are used for convenience and to aid understanding of relative positions or directions, and not intended to limit the orientation of any device, structure or any part of any device or structure. In addition, the singular terms “a”, “an”, and “the” include plural references unless context clearly indicates otherwise. Similarly, the word “or” is intended to include “and” unless the context clearly indicates otherwise.

The term “coupled” (or “connected”) herein may be understood as electrically coupled or as mechanically coupled, for example attached or fixed, or just in contact without any fixation, and it will be understood that both direct coupling or indirect coupling (in other words: coupling without direct contact) may be provided.

Throughout the description, the term “module” may be understood as an application specific integrated circuit (ASIC), an electronic circuit, a combinational logic circuit, a field programmable gate array (FPGA), a processor which executes code, other suitable hardware components which provide the described functionality, or any combination thereof. The term of “module” may include a memory which stores code executed by the processor.

In order that the invention may be readily understood and put into practical effect, various embodiments will now be described by way of examples and not limitations, and with reference to the figures.

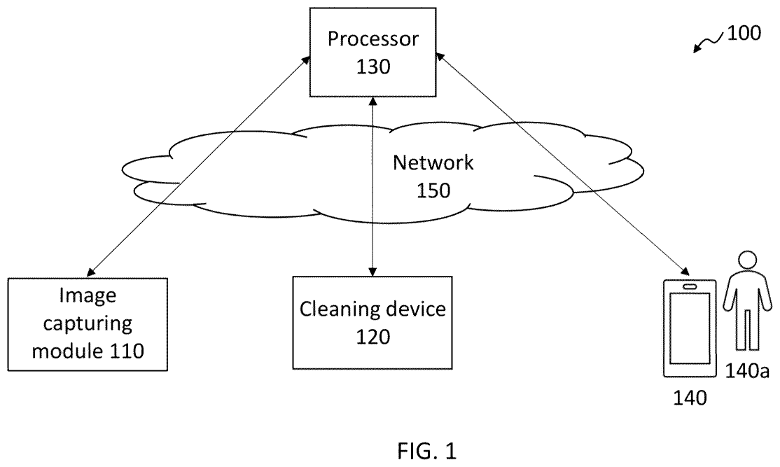

FIG. 1 illustrates an infrastructure of a system 100 for facilitating cleaning an area according to various embodiments.

As shown in FIG. 1, the system 100 may include, but not be limited to, an image capturing module 110, at least one cleaning device 120, and a processor 130. In some embodiments, the system 100 may further include at least one electronic device 140 and a network 150.

In some embodiments, the network 150 may include, but not be limited to, a Local Area Network (LAN), a Wide Area Network (WAN), a Global Area Network (GAN), or any combination thereof. The network 150 may provide a wireline communication, a wireless communication, or a combination of the wireline and wireless communication between the processor 130 and the image capturing module 110, between the processor 130 and the at least one cleaning device 120, and between the processor 130 and the at least one electronic device 140.

In some embodiments, the image capturing module 110 may be communicatively couplable with the processor 130 via the network 150. In some embodiments, the image capturing module 110 may be arranged in data or signal communication with the processor 130 via the network 150. In some embodiments, the image capturing module 110 may be in a form of a camera, for example, an RGB camera. In some embodiments, the image capturing module 110 may capture an image of the area. The image may be at least one of a static image (also referred to as a “still image”) and sequences of images (also referred to as a “moving image” or a “video”). In some embodiments, the image capturing module 110 may generate a raw data image. Thereafter, the image capturing module 110 may send the raw data image to the processor 130. The processor 130 may receive the raw data image from the image capturing module 110 and process, for example interpret, the raw data image to obtain an image. In some embodiments, the obtained image may be stored in a memory (not shown).

In some embodiments, the image capturing module 110 may be mounted in an image capturing device. In some other embodiments, the image capturing module 110 may be mounted in other devices, for example, the cleaning device 120. In some embodiments, the image capturing module 110 may be positioned at a suitable location in a vicinity of the area to capture images associated with the area, for example, a floor of the area. For example, the image may comprise a target to be disposed of. The target may include, but not be limited to, a trash and a spillage.

In some embodiments, a plurality of image capturing modules (hereinafter, referred to as a “first image capturing module 111” and a “second image capturing module 112”) may be provided. In some embodiments, the plurality of image capturing modules 111, 112 may be mounted in a plurality of image capturing devices respectively. In some other embodiments, the plurality of image capturing modules 111, 112, may be mounted in the plurality of cleaning devices 121, 122 respectively. In some other embodiments, the first image capturing module 111 may be mounted in the image capturing device, and the second image capturing module 112 may be mounted in the cleaning device 120.

In some embodiments, the cleaning device 120 may be communicatively couplable with the processor 130 via the network 150. In some embodiments, the cleaning device 120 may be arranged in data or signal communication with the processor 130 via the network 150. In some embodiments, the cleaning device 120 may perform a task to dispose of the target. In some embodiments, the cleaning device 120 may be referred to as a cleaning robot. The cleaning device 120 may include a moving part configured to drive the cleaning device 120 to move on the floor, and a cleaning part configured to clean the area. The cleaning part may include at least one tool, for example, a vacuum cleaner, a mop and/or a pick-up tool. For example, the cleaning device 120 may suck the target such as the trash and/or dust from the floor using the vacuum cleaner. As another example, the cleaning device 120 may mop the floor to clean the target such as a spillage using the mop. As another example, the cleaning device 120 may pick up the target such as the trash using the pick-up tool.

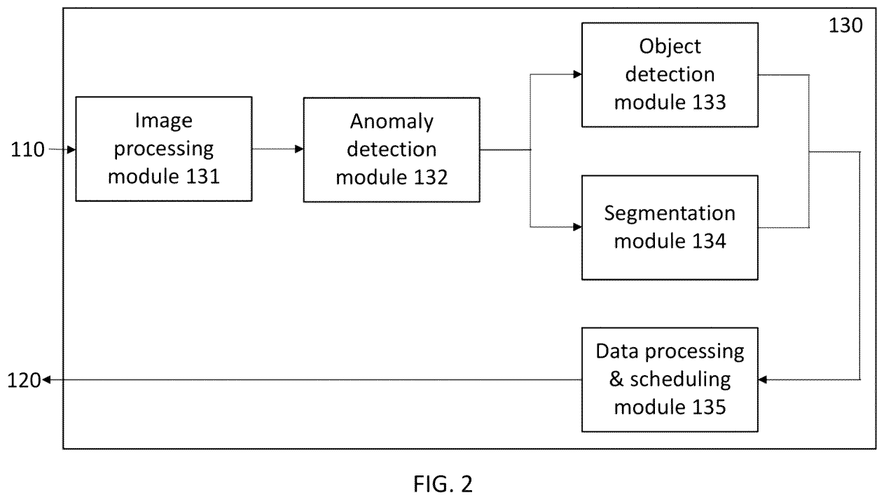

In some embodiments, the cleaning device 120 may include a communication interface (not shown) and a controller (not shown) to control the cleaning device 120. In some embodiments, the controller may include a CPU operable to receive the instructions via the communication interface. For example, the CPU may be the intermediary data control and a scheduling unit connecting to the processor 130. The scheduling unit of the cleaning device 120 may receive instructions from the processor 130, for example, a scheduling module 135 (as will be described with reference to FIG. 2), and direct the cleaning device 120 to a specific area for cleaning. For example, the communication interface of the cleaning device 120 may receive instructions to dispose of a trash from the processor 130 via the network 150. The controller of the cleaning device 120 may control the moving part to move on the floor to approach to the trash, and then control the pick-up tool to pick up the trash.

In some embodiments, a plurality of cleaning devices (hereinafter, referred to as a “first cleaning device 121” and a “second cleaning device 122”) may be provided. In some embodiments, the plurality of cleaning devices may have the same cleaning function. In some other embodiments, at least two cleaning devices of the plurality of cleaning devices may have different cleaning function. In some embodiments, the processor 130 may decide which cleaning device will perform a task to clean the area. The processor 130 may access information about capabilities of each cleaning device. For example, if the processor 130 determines that there is a trash on the floor, the processor 130 may instruct a cleaning device which is capable of picking up the trash to dispose of the trash. As another example, the processor 130 may instruct a cleaning device which is near the trash to dispose of the trash.

In some embodiments, the cleaning device 120 may receive the instructions to dispose of the target from the processor 130 and then send an acknowledgement to the processor 130. In some embodiments, if the cleaning device 120 receives the instructions to dispose of the target from the processor 130 and is unable to perform the task to dispose of the target, the processor 120 may notify the processor 130 accordingly.

In some embodiments, the processor 130 may include, but not be limited to, a microprocessor, an analogue circuit, a digital circuit, a mixed-signal circuit, a logic circuit, an integrated circuit, a Central Processing Unit (CPU), a Graphics Processing Unit (GPU), a Digital Signal Processor (DSP), a Field Programmable Gate Array (FPGA), an Application Specific Integrated Circuit (ASIC), or any combination thereof. Any other kind of implementation of the respective functions, which will be described below in further detail, may also be understood as the processor 130.

In some embodiments, the processor 130 may receive the raw data image from the image capturing module 110 and process, for example interpret, the raw data image to obtain the image, for example, the image comprising the target to be disposed of.

In some embodiments, the processor 130 may determine an attribute of the target and a location of the target from the image. For example, the attribute of the target may include at least one of a shape, a type and a colour of the target. In some embodiments, the processor 130 may control the cleaning device 120 to perform the task, based on the determined attribute of the target and the determined location of the target. For example, the processor 130 may send the instructions to the cleaning device 120 to dispose of the target, based on the determined attribute of the target and the determined location of the target. In some embodiments, the processor 130 may detect a rough shape of the target from the image, and process the image in a different manner based on whether the target is of regular shape or irregular shape to determine the attribute of the target and the location of the target (as will be described with reference to FIG. 2).

In some embodiments, the electronic device 140 may be communicatively couplable with the processor 130 via the network 150. In some embodiments, the electronic device 140 may be arranged in data or signal communication with the processor 130 via the network 150. In some embodiments, the electronic device 140 may include, but not be limited to, at least one of the following: a mobile phone, a tablet computer, a laptop computer, a desktop computer, a head-mounted display, and a smart watch. In some embodiments, the electronic device 140 may belong to a user 140a.

In some embodiments, if the cleaning device 120 is unable to perform the task to dispose of the target, the processor 130 may send a notification to the electronic device 140 of the user 140a, so that the user 140a may dispose of the target manually. For example, the user 140a may be a designated cleaner for the area.

In some embodiments, a plurality of electronic devices (hereinafter, referred to as a “first electronic device 141” and a “second electronic device 142”) may be provided. For example, the first electronic device 141 may belong to a first user 141a, and the second electronic device 142 may belong to a second user 142a.

In some embodiments, if the cleaning device 120 is unable to perform the task to dispose of the target, the processor 130 may select one of the plurality of electronic devices based on a distance between each electronic device and the target, and send a notification to the selected electronic device.

FIG. 2 illustrates a block diagram of a processor 130 included in a system 100 for facilitating cleaning an area according to various embodiments.

As shown in FIG. 2, the processor 130 may include, but not be limited to, an image processing module 131, an anomaly detection module 132, an object detection module 133, a segmentation module 134 and a data processing and scheduling module 135 (hereinafter, referred to as a “scheduling module”).

As shown in FIG. 2, in some embodiments, the image capturing module 110 may be communicatively couplable with the image processing module 131. In some embodiments, the image capturing module 110 may generate the raw data image. Thereafter, the image capturing module 110 may send the raw data image to the image processing module 131. The image processing module 131 may receive the raw data image from the image capturing module 110 and process, for example interpret, the raw data image to obtain the image.

In some embodiments, the image processing module 131 may be used to buffer and process the raw images captured from the image capturing module 110, for example, using image selection, quality enhancement, and/or image resizing, etc., so that the processed image can be readable by at least one of the anomaly detection module 132, the object detection module 133, and the segmentation module 134. For example, the image processing module 131 may convert the image into a format readable (for example, in terms of resolution) by the at least one of the anomaly detection module 132, the object detection module 133, and the segmentation module 134. As an example, an input required by the image processing module 131 may be in an RGB format (for example, 24-bit).

In some embodiments, the anomaly detection module 132 may be communicatively couplable with the image processing module 131. In some embodiments, the anomaly detection module 132 may receive the image from the image processing module 131. The anomaly detection module 132 may identify a region of interest associated with the target from the image using an anomaly detection model.

In some embodiments, the anomaly detection model may be one of artificial intelligence models implemented in the processor 130. For example, the anomaly detection model may be a machine/deep learning model. In some embodiments, the anomaly detection model may be based on an autoencoder. The anomaly detection model may identify rare items or observations which raise suspicions by differing from a majority of the data. In this manner, the anomaly detection module 132 may identify a possible anomaly area (i.e. the region of interest) which possibly has the target such as the trash and/or the spillage.

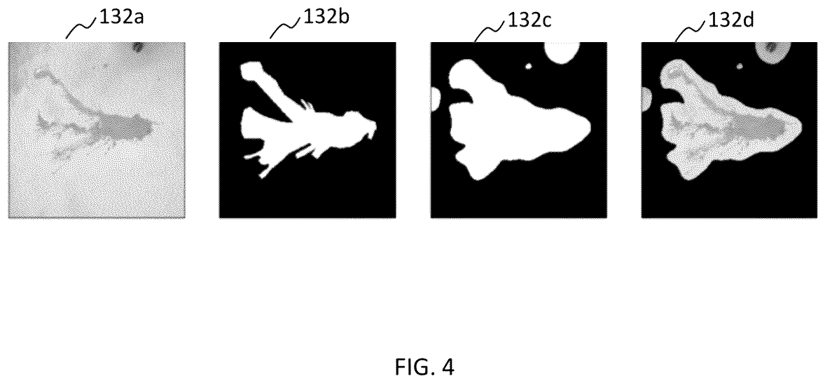

In some embodiments, the anomaly detection module 132 may detect the rough shape of the target from the image using the anomaly detection model. To detect the rough shape of the target, the anomaly detection module 132 may convert the image into a ground truth image, convert the ground truth image into a predicted mask image, and then convert the predicted mask image into a predicted anomalous image (as will be described with reference to FIG. 4).

In some embodiments, once an anomaly (i.e. the target) and the region of interest are detected by the anomaly detection module 132, the target area information (for example, in coordinates) and extracted region of interest may be provided to the object detection module 133 and/or the segmentation module 134.

In some embodiments, the object detection module 133 may be communicatively couplable with the anomaly detection module 132. In some embodiments, if the anomaly detection module 132 detects that the target is of the regular shape, the anomaly detection module 132 may determine that the target is a trash and send information about the region of interest to the object detection module 133. The object detection module 133 may determine the attribute of the target and the location of the target based on the received information about the region of interest, using an object detection model.

In some embodiments, the object detection model may be one of artificial intelligence models implemented in the processor 130. For example, the object detection model may be a machine/deep learning model including a YOLO v5 detection model. In some embodiments, the object detection model may detect instances of objects of a certain class within the image. The object detection model may be suitable for detecting the objects having relatively regular shapes and colour features. It may be appreciated that the trash (for example, cups, boxes, paper bags, etc.) normally has relatively regular shapes and colour features. The object detection module 133 may identify the location of the trash if it appears in the images. In this manner, the object detection module 133 may determine the attribute of the target and the location of the target, if it is determined that the target is the trash.

In some embodiments, the segmentation module 134 may be communicatively couplable with the object detection module 133. In some embodiments, if the anomaly detection module 132 detects that the target is of the irregular shape, the anomaly detection module 132 may determine that the target is a spillage and send information about the region of interest to the segmentation module 134. The segmentation module 134 may determine the attribute of the target and the location of the target based on the received information about the region of interest, using a segmentation model.

In some embodiments, the segmentation model may be one of artificial intelligence models implemented in the processor 130. For example, the segmentation model may be a machine/deep learning model. In some embodiments, the segmentation model may divide the image into multiple segments and each pixel in the image may be associated with an object type. For example, the segmentation model may include a semantic segmentation model and/or an instance segmentation model. By using the segmentation model, an annotation may be provided in a format of polygons. Due to the irregular shape of the spillage (for example, in liquid), a detection accuracy may not be satisfactory using the objection detection model. The segmentation model may be suitable for detecting the spillage which is of the irregular shape.

In some embodiments, if the anomaly detection module 132 detects that there are a plurality of targets which are of the regular shape and the irregular shape respectively, the anomaly detection module 132 may determine that the targets are a trash and a spillage, and send information about the region of interest to the object detection module 133 and the segmentation module 134 respectively.

In some embodiments, the scheduling module 135 may be communicatively couplable with the object detection module 133 and the segmentation module 134 respectively. In some embodiments, the scheduling module 135 may receive the determined attribute of the target and the determined location of the target from the object detection module 133 and/or the segmentation module 134.

In some embodiments, the scheduling module 135 may be communicatively couplable with the cleaning device 120. In some embodiments, the scheduling module 135 may control the cleaning device 120 to move to the determined location of the target and to perform the task in a predetermined manner based on the determined attribute of the target.

In some embodiments, if the cleaning device 120 is unable to perform the task, the scheduling module 135 may send a notification to the electronic device 140 of the user 140a.

In some embodiments, the machine/deep learning models may be used to deal with the various lighting conditions and/or surface colour features/shapes in working environments.

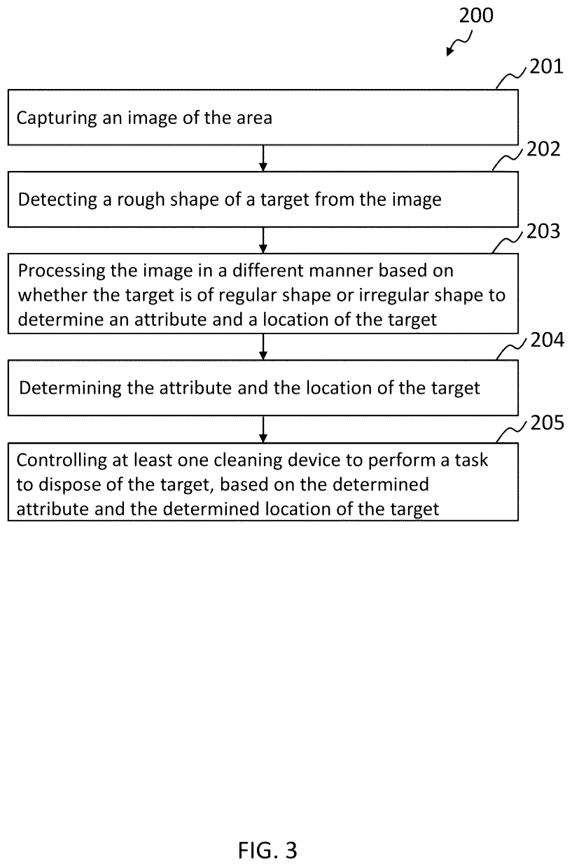

FIG. 3 illustrates a flowchart of a method 200 for facilitating cleaning an area according to various embodiments. According to the various embodiments, the method 200 for facilitating cleaning the area may be provided.

In some embodiments, the method 200 may include a step 201 of capturing an image of the area. For example, the image may comprise a target to be disposed of.

In some embodiments, the method 200 may include a step 202 of detecting a rough shape of the target from the image.

In some embodiments, the method 200 may include a step 203 of processing the image in a different manner based on whether the target is of regular shape or irregular shape to determine an attribute of the target and a location of the target.

In some embodiments, the method 200 may include a step 204 of determining the attribute of the target and the location of the target.

In some embodiments, the method 200 may include a step 205 of controlling at least one cleaning device to perform a task to dispose of the target, based on the determined attribute of the target and the determined location of the target.

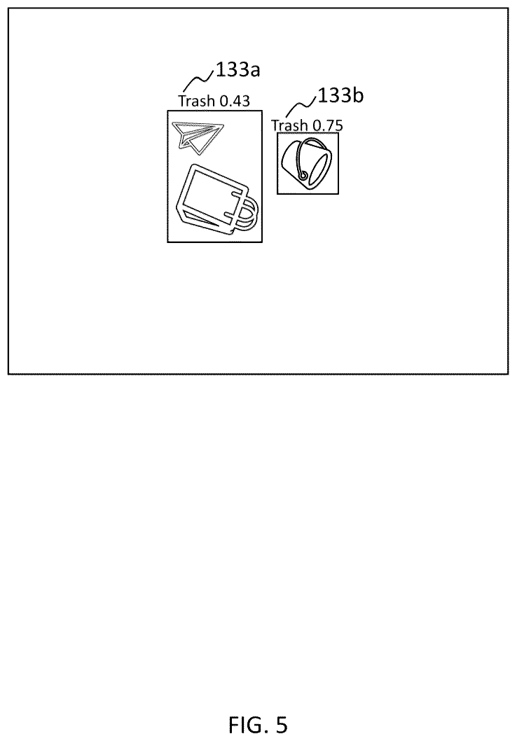

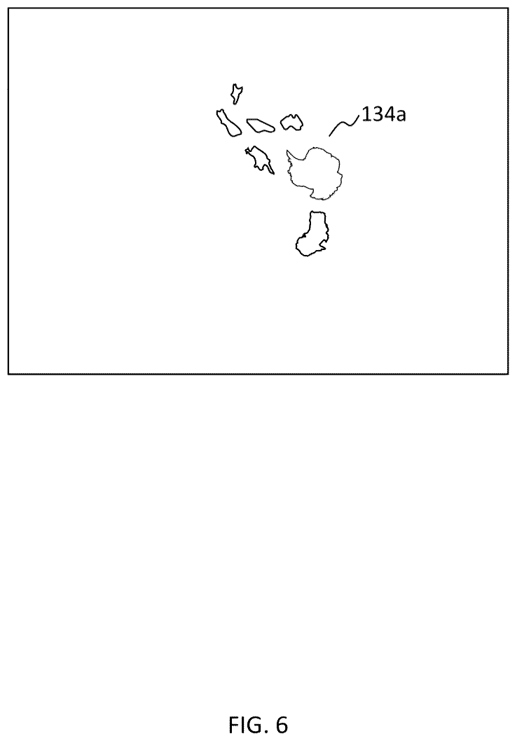

FIG. 4 illustrates exemplary images processed by an anomaly detection module 132 according to various embodiments. FIG. 5 illustrates an exemplary image processed by an object detection module 133 according to various embodiments. FIG. 6 illustrates an exemplary image processed by a segmentation module 134 according to various embodiments.

As shown in FIG. 4, the anomaly detection module 132 may detect the rough shape of the target using the anomaly detection model. To detect the rough shape of the target, the anomaly detection module 132 may convert the image 132a received from the image processing module 131 into a ground truth image 132b. The anomaly detection module 132 may then convert the ground truth image 132b into a predicted mask image 132c. The anomaly detection module 132 may then convert the predicted mask image 132c into a predicted anomalous image 132d. The anomaly detection module 132 may detect from the predicted anomalous image 132d that the target is of the irregular shape. The anomaly detection module 132 may determine that the target is a trash, and send information about the region of interest to the object detection module 133.

If the anomaly detection module 132 detects that the target is of the regular shape, the anomaly detection module 132 may determine that the target is a trash and send information about the region of interest to the object detection module 133. The object detection module 133 may determine the attribute, for example, the shape, and the location of the target based on the received information, using the object detection model. For example, as shown in FIG. 5, the object detection module 133 may detect that the trashes are a paper airplane, a paper bag, and a bucket respectively. The object detection module 133 may calculate each confidence score that the detected trashes are the paper airplane, the paper bag, and the bucket respectively. As shown in FIG. 5, the object detection module 133 may display bounding box surrounding the corresponding trash on the image. The object detection module 133 may further display the calculated confidence scores 133a, 133b adjacent to the corresponding bounding box in the image. The confidence scores 133a, 133b may be the probabilities to recognize the trash and/or the spillage. For example, if a high confidence score is set, this means that the detection criteria is strict. As another example, if a low confidence score is set, this means that the detection criteria is less strict.

If the anomaly detection module 132 detects that the target is of the irregular shape, the anomaly detection module 132 may determine that the target is a spillage and send information about the region of interest to the segmentation module 134. The segmentation module 134 may determine the attribute, for example, the shape, of the target and the location of the target based on the received information, using the segmentation model. For example, as shown in FIG. 6, the segmentation module 134 may display an annotation associated with the determined shape of the spillage 134a in the format of polygon, on the image. For example, the image showing the annotation in the format of polygon may be referred to as a confidence map. Although not shown, in some embodiments, the segmentation module 134 may display the annotation in a certain colour, for example, purple colour.

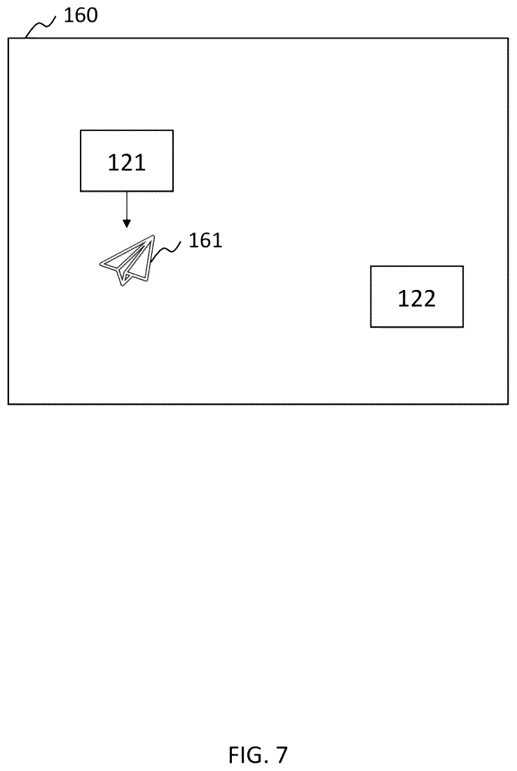

FIGS. 7 to 10 illustrate exemplary views showing operations of at least one cleaning device 120 according to various embodiments.

In some embodiments, the scheduling module 135 may receive the determined attribute of the target and the determined location of the target from the object detection module 133 and/or the segmentation module 134. The scheduling module 135 may control the at least one cleaning device 120 to move to the determined location of the target and to perform the task in the predetermined manner based on the determined attribute of the target. For example, the plurality of cleaning devices 120 are provided.

As shown in FIG. 7, a first cleaning device 121 which is capable of disposing of the trash, and a second cleaning device 122 which is capable of disposing of the trash may be deployed in the area 160. A distance between the trash and the first cleaning device 121 is shorter than a distance between the trash and the second cleaning device 122. If the scheduling module 135 receives the determined attribute and the determined location of the target which is the trash, for example, the paper airplane 161, from the object detection module 133, the scheduling module 135 may control the first cleaning device 121 to move to the determined location and to perform the task to dispose of the trash in the predetermined manner, for example, by picking up the trash.

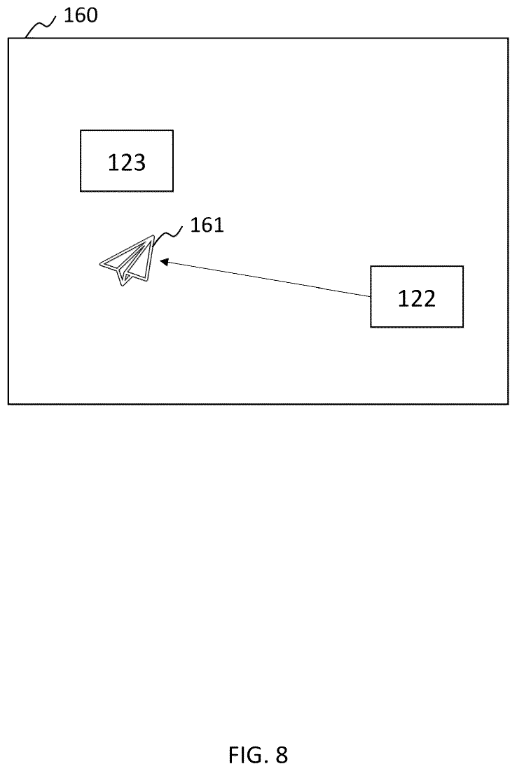

As shown in FIG. 8, the second cleaning device 122 which is capable of disposing of the trash, and a third cleaning device 123 which is not capable of disposing of the trash but capable of disposing of the spillage may be deployed in the area 160. A distance between the trash and the third cleaning device 123 is shorter than a distance between the trash and the second cleaning device 122. If the scheduling module 135 receives the determined attribute and the determined location of the target which is the trash, for example, the paper airplane 161, from the object detection module 133, the scheduling module 135 may control the second cleaning device 122 to move to the determined location and to perform the task to dispose of the trash in the predetermined manner, for example, by picking up the trash.

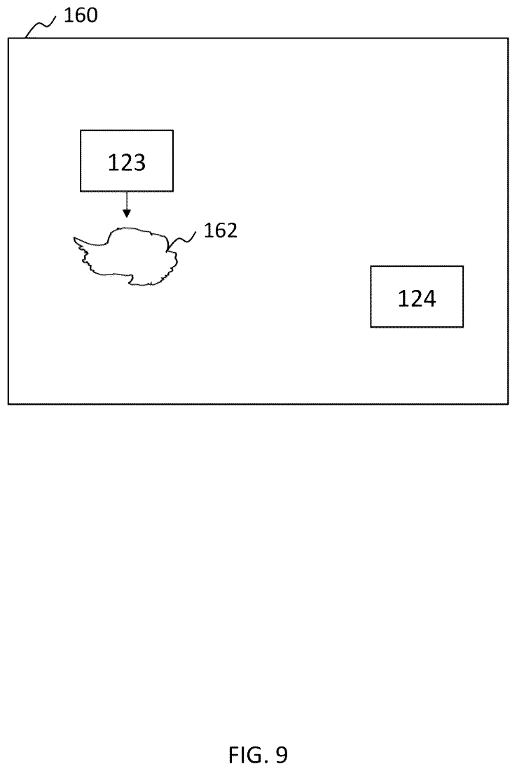

As shown in FIG. 9, the third cleaning device 123 which is capable of disposing of the spillage, and a fourth cleaning device 124 which is capable of disposing of the spillage may be deployed in the area 160. A distance between the trash and the third cleaning device 123 is shorter than a distance between the trash and the fourth cleaning device 124. If the scheduling module 135 receives the determined attribute and the determined location of the target which is the spillage, for example, spilled liquid 162, from the segmentation module 134, the scheduling module 135 may control the third cleaning device 123 to move to the determined location and to perform the task to dispose of the spillage in the predetermined manner, for example, by mopping the spillage.

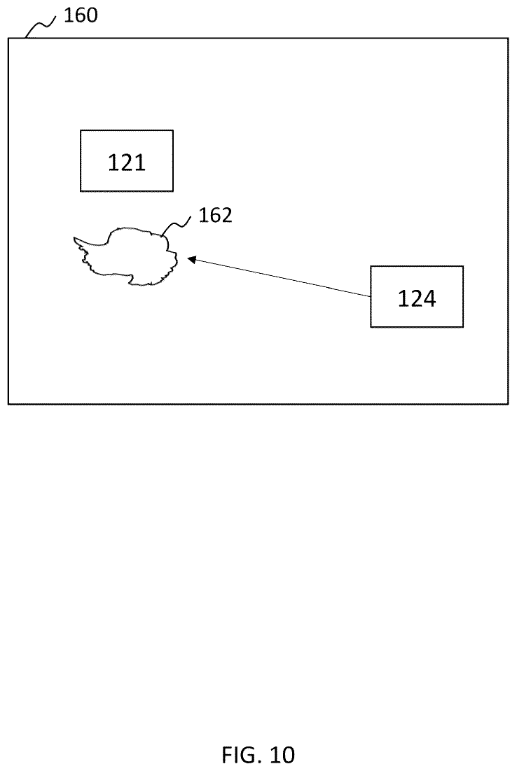

As shown in FIG. 10, the first cleaning device 121 which is not capable of disposing of the spillage but capable of disposing of the trash, and the fourth cleaning device 124 which is capable of disposing of the spillage may be deployed in the area 160. A distance between the trash and the first cleaning device 121 is shorter than a distance between the trash and the fourth cleaning device 124. If the scheduling module 135 receives the determined attribute and the determined location of the target which is the spillage, for example, spilled liquid 162, from the segmentation module 134, the scheduling module 135 may control the fourth cleaning device 124 to move to the determined location and to perform the task to dispose of the spillage in the predetermined manner, for example, by mopping the spillage.

As described, in accordance with various embodiments, computer vision and deep learning applications may be provided. A combination of the machine/deep learning algorithms may be used to identify the target, and automatically detect the trash and the spillage to guide the work of the cleaning device 120. Although not shown, the machine/deep learning algorithms may be trained to improve the accuracy in various working environments and reduce efforts in manual data collection and annotation processes.

Although not shown, in accordance with various embodiments, on the data collection side, more smart cameras and network modules may be added to provide real-time/recorded videos. If there is other application requirement (e.g., in face/person detection), these models may be deployed together with current models to obtain target results.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced. It will be appreciated that common numerals, used in the relevant drawings, refer to components that serve a similar or the same purpose. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

We claim:

1. A system for facilitating cleaning an area, the system comprising:
an image capturing module configured to capture an image of the area, the image comprising a target to be disposed of;
at least one cleaning device configured to perform a task to dispose of the target; and
a processor communicatively couplable with the image capturing module and the at least one cleaning device, and configured to:
receive the image from the image capturing module;
determine an attribute of the target and a location of the target from the image; and
control the at least one cleaning device to perform the task, based on the determined attribute of the target and the determined location of the target,
wherein the processor is further configured to detect a rough shape of the target from the image, and process the image in a different manner based on whether the target is of regular shape or irregular shape to determine the attribute of the target and the location of the target.

2. The system, according to claim 1, wherein the processor comprises an anomaly detection module configured to identify a region of interest associated with the target from the image using an anomaly detection model.

3. The system, according to claim 2, wherein the anomaly detection module is further configured to detect the rough shape of the target from the image using the anomaly detection model.

4. The system, according to claim 3, wherein the processor comprises an object detection module; and
wherein if the anomaly detection module detects that the target is of the regular shape, the anomaly detection module is configured to determine that the target is a trash and send information about the region of interest to the object detection module.

5. The system, according to claim 4, wherein the object detection module is configured to determine the attribute of the target and the location of the target based on the received information, using an object detection model.

6. The system, according to claim 5, wherein the processor comprises a segmentation module; and
wherein if the anomaly detection module detects that the target is of the irregular shape, the anomaly detection module is configured to determine that the target is a spillage and send information about the region of interest to the segmentation module.

7. The system, according to claim 6, wherein the segmentation module is configured to determine the attribute of the target and the location of the target based on the received information, using a segmentation model.

8. The system, according to claim 7, wherein the processor comprises an image processing module configured to convert the image into a format readable by at least one of the anomaly detection module, the object detection module, and the segmentation module.

9. The system, according to claim 7, wherein the processor comprises a scheduling module configured to receive the determined attribute of the target and the determined location of the target from the object detection module and/or the segmentation module, and control the at least one cleaning device to move to the determined location of the target and to perform the task in a predetermined manner based on the determined attribute of the target.

10. The system, according to claim 9, wherein if the at least one cleaning device is unable to perform the task, the scheduling module is further configured to send a notification to an electronic device of a user.

11. The system, according to claim 1, wherein the attribute of the target includes at least one of a shape, a type and a colour of the target.

12. A method for facilitating cleaning an area, the method comprising the following steps:
capturing an image of the area, the image comprising a target to be disposed of;
detecting a rough shape of the target from the image;
processing the image in a different manner based on whether the target is of regular shape or irregular shape to determine an attribute of the target and a location of the target;
determining the attribute of the target and the location of the target; and
controlling at least one cleaning device to perform a task to dispose of the target, based on the determined attribute of the target and the determined location of the target.

13. The method, according to claim 12, further comprising the step of: identifying a region of interest associated with the target from the image using an anomaly detection model.

14. The method, according to claim 13, wherein the step of detecting a rough shape of the target from the image comprises the step of: detecting the rough shape of the target from the image using the anomaly detection model.

15. The method, according to claim 14, further comprising the step of: if it is detected that the target is of the regular shape, determining that the target is a trash; and inputting information about the region of interest into an object detection model.

16. The method, according to claim 15, wherein the step of determining the attribute of the target and the location of the target comprises the step of: determining the attribute of the target and the location of the target based on the inputted information, using the object detection model.

17. The method, according to claim 16, further comprising the steps of: if it is detected that the target is of the irregular shape, determining that the target is a spillage; and inputting information about the region of interest into a segmentation model.

18. The method, according to claim 17, wherein the step of determining the attribute of the target and the location of the target comprises the step of: determining the attribute of the target and the location of the target based on the inputted information, using the segmentation model.

19. The method, according to claim 12, wherein the step of controlling at least one cleaning device to perform a task to dispose of the target comprises the step of: controlling the at least one cleaning device to move to the determined location of the target and to perform the task in a predetermined manner based on the determined attribute of the target.

20. The method, according to claim 12, further comprising the step of: if the at least one cleaning device is unable to perform the task, sending a notification to an electronic device of a user.
